(19) United States
(12) Patent Application Publication
(10) Pub. No.: US 2013/0099603 A1
(43) Pub. Date: Apr. 25, 2013

(54) LINEAR VIBRATOR

(71) Applicant: Kapjin Lee, Seoul (KR)

(72) Inventor: Kapjin Lee, Seoul (KR)

(73) Assignee: LG INNOTEK CO., LTD., Seoul (KR)

(21) Appl. No.: 13/807,601

(22) PCT Filed: Jul. 1, 2011
(86) PCT No.: PCT/KR11/04853

§ 371 Date: Dec. 28, 2012

(30) Foreign Application Priority Data
Jul. 12, 2010 (KR) 10-2010-0067046

(51) Int. Cl. H02K 1/34

(52) U.S. Cl. CPC H02K 1/34
USPC 310/25

(57) ABSTRACT

A linear vibrator is disclosed, comprising: a case including a bottom-opened upper case and a plate-shaped bottom case coupled to the upper case to form an accommodation space; a stator including a circuit substrate arranged at an inner lateral surface of the bottom case and a cylindrical coil block arranged on the circuit substrate to receive a driving signal; and a vibrator including a first magnet arranged inside the coil block to generate a first magnetic flux to an axial direction of the coil block, a second magnet arranged outside of the coil block to generate a second magnetic flux to a direction facing the coil block, a yoke fixing the first and second magnets, and an elastic member elastically fixing the yoke to the upper case.

### TECHNICAL FIELD

The present invention relates to a linear vibrator.

### BACKGROUND ART

Recently, a linear vibrator is applied to various electronic devices, such as mobile phones, MP3 players, mobile game players, joy sticks, and game controllers to generate vibration.

A coin-type linear vibrator, one of the linear vibrators, generates a vibration by vertically moving a weight using a force generated by a magnetic field of a coil and a magnetic field generated by a magnet. A conventional linear vibrator takes the shape of a cylinder, and includes a coil block generating a magnetic field and a magnet arranged within the coil block and coupled to a case.

The conventional linear vibrator generates a vibration by the magnet being driven inside the coil block using a force generated by a magnetic field generated by a current applied to the coil block and by a magnetic field generated by the magnet.

However, the linear vibrator arranged inside the coil block is problematic due to difficulty in generating a sufficient frequency caused by limitation in size of the magnet and the coil block.

### DISCLOSURE OF INVENTION

### Technical Problem

The present invention is disclosed to provide a linear vibrator capable of changing structure and arrangement of a magnet driven by a magnetic field generated by a coil block to further improve a bandwidth and vibration quantity.

Technical problems to be solved by the present invention are not restricted to the above-mentioned, and any other technical problems not mentioned so far will be clearly appreciated from the following description by skilled in the art.

### Solution to Problem

An object of the present invention is to solve at least one or more of the above problems and/or disadvantages in a whole or in part and to provide at least the advantages described hereinafter. In order to achieve at least the above objects, in whole or in part, and in accordance with the purposes of the disclosure, as embodied and broadly described, there is provided a linear vibrator according to an exemplary embodiment of the disclosure, the linear vibrator comprising: a case including a bottom-opened upper case and a plate-shaped bottom case coupled to the upper case to form an accommodation space; a stator including a circuit substrate arranged at an inner lateral surface of the bottom case and a cylindrical coil block arranged on the circuit substrate to receive a driving signal; and a vibrator including a first magnet arranged inside the coil block to generate a first magnetic flux to an axial direction of the coil block, a second magnet arranged outside of the coil block to generate a second magnetic flux to a direction facing the coil block, a yoke fixing the first and second magnets, and an elastic member elastically fixing the yoke to the upper case.

In another general aspect of the present invention, there is provided a linear vibrator, comprising: a case forming an accommodation space; a circuit substrate arranged on a floor plate of the case; a coil block electrically connected to the circuit substrate to form a space therein; a magnet including a first magnet arranged in opposition to the space of the coil block and a second magnet arranged at an exterior of the coil block; a yoke securing the first and second magnets; and an elastic member elastically securing the yoke to the case.

### Advantageous Effects of Invention

The linear vibrator according to the present invention is advantageous in that a first magnet is formed inside a coil block, and a second magnet is formed at a periphery of the coil block to generate a magnetic flux facing the coil block to greatly improve a vibration bandwidth and frequency of the linear vibrator.

### BRIEF DESCRIPTION OF DRAWINGS

The teachings of the present invention can be readily understood by considering the following detailed description in conjunction with the accompanying drawings, in which:

FIG. 1 is an exploded perspective view illustrating a linear vibrator according to an exemplary embodiment of the present invention;

FIG. 2 is a cross-sectional view of the linear vibrator illustrated in FIG. 1;

FIG. 3 is a cross-sectional view illustrating a linear vibrator according to another exemplary embodiment of the present invention; and

FIG. 4 is a cross-sectional view illustrating a linear vibrator according to another exemplary embodiment of the present invention.

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

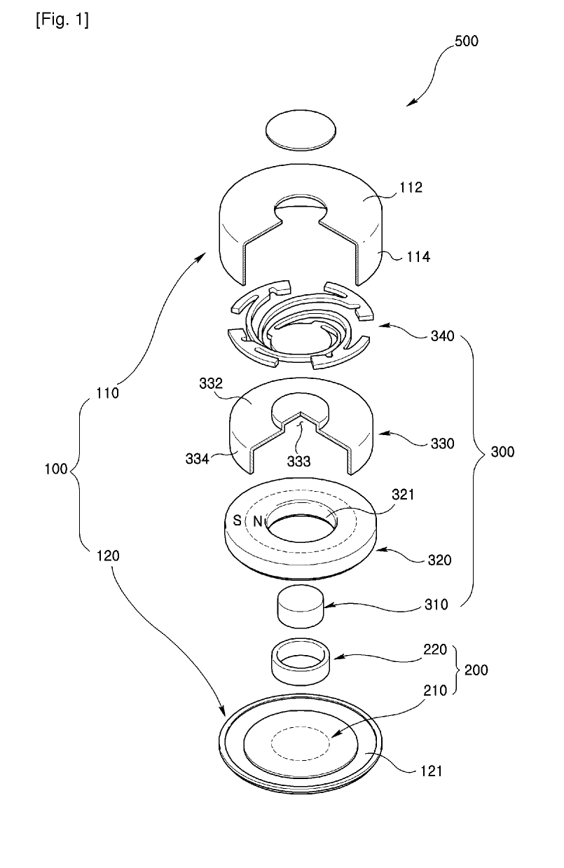

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best.

It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout, and explanations that duplicate one another will be omitted. Now, the present invention will be described in detail with reference to the accompanying drawings.

A linear vibrator according to exemplary embodiments of the present invention will be described in detail with reference to the following drawings.

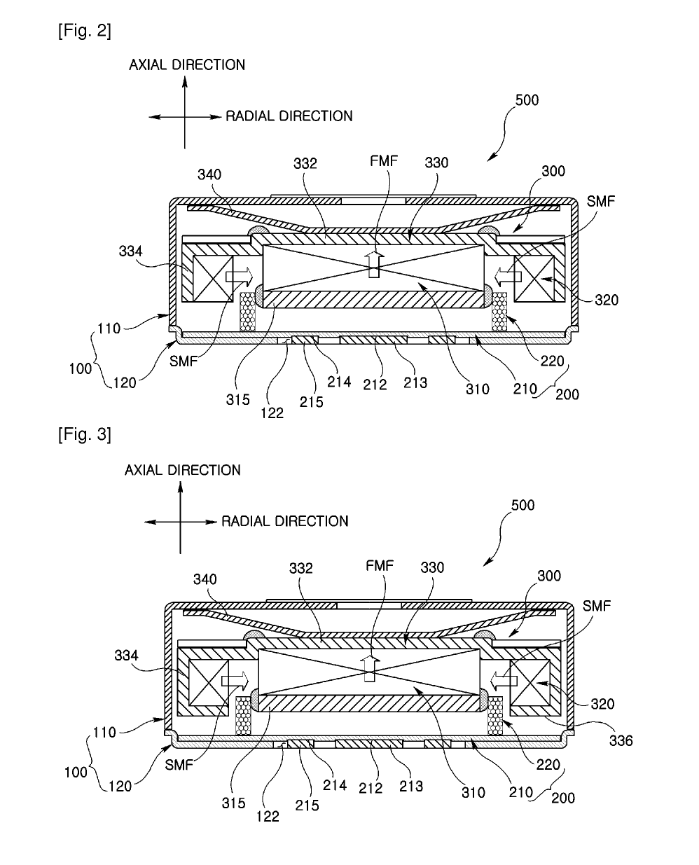

FIG. 1 is an exploded perspective view illustrating a linear vibrator according to an exemplary embodiment of the present invention, and FIG. 2 is a cross-sectional view of the linear vibrator illustrated in FIG. 1.

Referring to FIGS. 1 and 2, a linear vibrator (500) includes a case (100), a stator (200) and a vibrator (300). The case includes an upper case (110) and a bottom case (120). In the exemplary embodiment of the present invention, the upper case (110) and the bottom case (120) form an accommodation space for accommodating the stator (200) and the vibrator (300), both of which will be described later.

The upper case (110) takes the shape of a bottom-opened barrel. For example, the upper case (110) takes the shape of a bottom-opened cylinder. The upper case (110) includes an upper plate (112) and a lateral plate (114). The upper plate (112) takes the shape of a disk, for example, and the lateral plate (114) takes the shape extended to a bottom along an edge of the upper plate (112). The bottom case (120) takes the shape of a disk, and is coupled to a distal end of the lateral plate (114) of the upper case (110). In the exemplary embodiment of the present invention, the bottom case (120) is centrally formed with an opening (122).

The stator (200) is arranged on the bottom case (120). The stator (200) includes a circuit substrate (210) and a coil block (220). The circuit substrate (210) is arranged at an upper surface (121) of the bottom case (120), for example. The circuit substrate (210) may take various shapes including a disk, a cuboidal plate and a square plate, when viewed in a top plan view.

A rear surface of the circuit substrate (210) opposite to the upper surface (121) of the bottom case (120) is arranged with connection terminals (212, 214), and is formed with an opening (122) exposing the connection terminals (212, 214). Each of the connection terminals (212, 214) may be connected to connection members (213, 215) including a metal of low melting point such as a solder having a low melting temperature.

In the exemplary embodiment of the present invention, each thickness of the connection members (213, 215) is preferably formed with a thickness thinner than that of the bottom case (120), for example. The connection members (213, 215) may be electrically connected to connection terminals of an external circuit substrate by way of surface mounting technology. The circuit substrate (210) and the bottom case (120) may be mutually bonded by an adhesive member.

The coil block (220) is arranged at an upper surface of the circuit substrate (210), takes the shape of a cylinder or a pipe to form a space therein, and is formed by winding a long insulated wire in the shape of a cylinder or a pipe. Both distal ends of the wire forming the coil block (220) are electrically connected to the circuit substrate (210), and a driving signal such as a current applied from the connection terminals (212, 214) of the circuit substrate is applied to the coil block (220) through the circuit substrate (210).

The coil block (220) is formed with a magnetic field by the driving signal, and direction of the magnetic field is determined by a direction of the current which is the driving signal applied to the coil block (220). Although the exemplary embodiment of the present invention illustrated and explained the coil block (220) takes the shape of a cylinder, the coil block may take various other shapes including a square pillar formed with a space.

The vibrator (300) is arranged in a space formed by the upper case (110) and the bottom case (120), and elastically secured to the upper case (110), for example.

Referring to FIGS. 1 and 2 again, the vibrator (300) includes a first magnet (310), a second magnet (320), a yoke (330) and an elastic member (340).

The yoke (330) takes the shape of a bottom-opened cylinder, and serves to fix the first and second magnets (310, 320) and to prevent a magnetic field generated by the first and second magnets (310, 320) from leaking. To this end, the yoke (330) is formed by processing a metal plate. The yoke (330) includes a yoke upper plate (332) and a yoke lateral plate (334).

The yoke upper plate (332) takes the shape of a disk, for example, and the yoke lateral plate (334) is extended from an edge of the yoke upper plate (332) to the bottom case (120). An accommodation space for accommodating the first and second magnets (310, 320) is formed inside the yoke (330) by the yoke upper plate (332) and the yoke lateral plate (334). The yoke upper plate (332) may be centrally formed with a concave coupling groove (333) protruded from an inner surface of the yoke upper plate (332) to a periphery of the yoke upper plate (332) to secure the first magnet (310).

The first magnet (310) is arranged at a position opposite to the space of the coil block (220), and formed with a size appropriate enough to be inserted into the space of the coil block (220). The first magnet (310) takes the shape of a pillar. The first magnet (310) takes the shape of a cylinder, for example, and generates a first magnetic flux (FMF) to an axial direction facing from the bottom case (120) to the upper case (110).

A bottom surface opposite to the bottom case (120) in the first magnet (310) may be formed with a front yoke (315). The front yoke (315) prevents the first magnetic flux (FMF) from leaking from the first magnet (310). An upper surface opposite to the bottom surface of the first magnet (310) formed with the front yoke (315) is arranged inside a coupling groove (333) formed at the center of the yoke upper plate (332), and the yoke upper plate (332) and the upper surface of the first magnet (310) may be mutually bonded by an adhesive.

The first magnet (310) coupled to the yoke upper plate (332) is arranged at a position opposite to an interior of the coil block (220) of the stator (200), and a predetermined gap is formed between an inner surface of the coil block (220) and the periphery of the first magnet (310). The second magnet (320) takes the shape of a doughnut or a circular ring, for example, and a periphery of the second magnet (320) is fixed by the yoke lateral plate (334). That is, the yoke lateral plate (334) of the yoke (330) encompasses the periphery of the second magnet (320), and the second magnet (320) is fixed to the inner surface of the yoke upper plate (332) and the inner surface of the yoke lateral plate.

An inner surface (321) of the doughnut-shaped second magnet (320) is arranged at an outside of the coil block (220). The inner surface (321) of the second magnet (320) and the periphery of the coil block (220) are distanced at a predetermined gap. In the exemplary embodiment of the present invention, the coil block (220) is interposed between the first and second magnets (310, 320).

The second magnet (320) faces the periphery of the coil block (220) to generate a second magnetic flux (SMF) opposite to a radial direction in parallel with an upper surface of the circuit substrate (210). The second magnetic flux (SMF) generated from the second magnet (320) and passing through the coil block (220) greatly improves the intensity of magnetic flux of the coil block (220).

The yoke upper plate (332) formed with the second magnet (320) and the yoke lateral plate (334) can greatly improve the intensity of magnetic flux of the coil block (220) by allowing the second magnetic flux (SMF) generated from the second magnet (320) to pass through the coil block (220) and to face the radial direction of the coil block (220).

In order to allow the second magnetic flux (SMF) generated from the second magnet (320) to pass through the coil block (220) and to face the radial direction of the coil block (220), a portion adjacent to the inner surface of the second magnet (320) may be magnetized with an N polarity, and a portion adjacent to the periphery facing the inner surface of the second magnet (320) may be magnetized with an S polarity opposite to the N polarity.

In the exemplary embodiment of the present invention, the vibration bandwidth of the linear vibrator (500) can be greatly improved or the vibration of the linear vibrator (500) can be greatly improved by allowing the second magnetic flux (SMF) generated from the second magnet (320) arranged at the exterior of the coil block (220) to pass the coil block (220) to a radial direction of the coil block (220). In the exemplary embodiment of the present invention, frequency generated from the linear the vibrator (500) may be in the range of 100 Hz˜300 Hz.

### MODE FOR THE INVENTION

FIG. 3 is a cross-sectional view illustrating a linear vibrator according to another exemplary embodiment of the present invention.

The linear vibrator illustrated in FIG. 3 has a substantially same structure as that of FIGS. 1 and 2 except for the yoke, such that like reference numerals refer to like elements throughout, and explanations that duplicate one another will be omitted.

Referring to FIG. 3, the linear vibrator (500) includes a case (100), a stator (200) and a vibrator (300). The vibrator (300) includes a first magnet (310), a second magnet (320), a yoke (330) and an elastic member (340). The yoke (330) includes a yoke upper plate (332), a yoke lateral plate (334) and a yoke bottom plate (336).

The yoke bottom plate (336) is bent from a distal end of the yoke lateral plate (334) to cover a bottom surface of the second magnet (320). In the exemplary embodiment of the present invention, the second magnet (320) is secured to the yoke upper plate (332) and an inner surface of the yoke lateral plate (334) using an adhesive, where the yoke bottom plate (336) is bent to encompasses a bottom surface of the second magnet (320).

In the exemplary embodiment of the present invention, the second magnetic flux (SMF) generated from the second magnet (320) by the yoke bottom plate (336) covering the bottom surface of the second magnet (320) by extending from the yoke lateral plate (334) is provided to the coil block (220) without any leakage, whereby the intensity of the magnetic flux generated from the coil block (220) can be further increased.

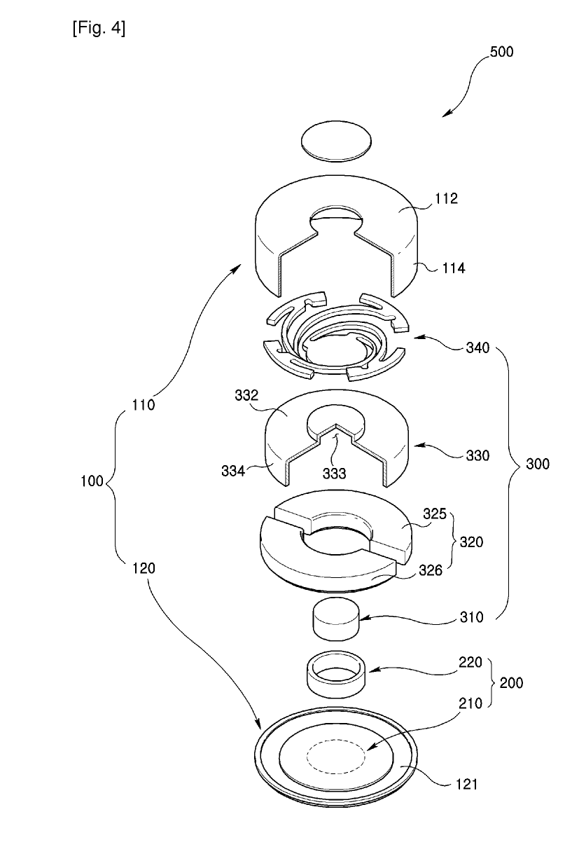

FIG. 4 is a cross-sectional view illustrating a linear vibrator according to another exemplary embodiment of the present invention.

The linear vibrator illustrated in FIG. 4 has a substantially same structure as that of FIGS. 1 and 2 except for the second magnet, such that like reference numerals refer to like elements throughout, and explanations that duplicate one another will be omitted.

Referring to FIG. 4, the linear vibrator (500) includes a case (100), a stator (200) and a vibrator (300). The vibrator (300) includes a first magnet (310), a second magnet (320), a yoke (330) and an elastic member (340). The second magnet (320) may include at least two C-shaped magnets. Two second magnets (320) may be arranged inside the yoke (330), each in the shape of doughnut, or three second magnets (320) may be arranged inside the yoke (330), each in the shape of a doughnut.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

### INDUSTRIAL APPLICABILITY

The linear vibrator according to the present invention has an industrial applicability in that a first magnet is formed inside a coil block, and a second magnet is formed at a periphery of the coil block to generate a magnetic flux facing the coil block to greatly improve a vibration bandwidth and frequency of the linear vibrator.

1. A linear vibrator comprising:
a case including a bottom-opened upper case and a plate-shaped bottom case coupled to the upper case to form an accommodation space;
a stator including a circuit substrate arranged at an inner lateral surface of the bottom case and a cylindrical coil block arranged on the circuit substrate to receive a driving signal; and
a vibrator including a first magnet arranged inside the coil block to generate a first magnetic flux to an axial direction of the coil block, a second magnet arranged outside of the coil block to generate a second magnetic flux to a direction facing the coil block, a yoke fixing the first and second magnets, and an elastic member elastically fixing the yoke to the upper case.

2. The linear vibrator of claim 1, wherein the second magnet is arranged on the yoke to allow the second magnetic flux to face to a radial direction of the coil block perpendicular to the axial direction.

3. The linear vibrator of claim 1, wherein the coil block takes the shape of a cylinder or a pipe.

4. The linear vibrator of claim 1, wherein the yoke includes a yoke upper plate and a yoke lateral plate extended from an edge of the yoke upper plate to the circuit substrate, wherein an inner lateral surface of the yoke upper plate corresponding to an interior of the coil block is arranged with the first magnet, and an inner lateral surface of the yoke lateral plate corresponding to an exterior of the coil block is arranged with the second magnet.

5. The linear vibrator of claim 4, wherein the yoke includes a yoke bottom plate covering a bottom surface of the second magnet from the yoke lateral plate to encompass the bottom surface of the second magnet.

6. The linear vibrator of claim 1, wherein an upper surface of the yoke is arranged with one of a magnetic iron piece or a weight.

7. The linear vibrator of claim 1, wherein the first magnet takes the shape of a cylinder, and the second magnet takes the shape of a circular ring.

8. The linear vibrator of claim 7, wherein the second magnet is formed at an inner surface with an N polarity, and a periphery of the second magnet opposite to the inner surface is formed with an S polarity.

9. The linear vibrator of claim 1, wherein the first magnet takes the shape of a cylinder, and the second magnet takes the shape of a ring formed with a plurality of circular rings.

10. The linear vibrator of claim 1, wherein frequency of the vibrator is in the range of 100 Hz˜300 Hz.

11. The linear vibrator of claim 1, wherein a bottom surface of the circuit substrate opposite to the bottom case is formed with a connection terminal, and the bottom case is formed with an opening exposing the connection terminal.

12. The linear vibrator of claim 11, wherein the connection terminal is arranged with a connection member formed with a height lower than thickness of the bottom case.

13. A linear vibrator, characterized by: a case forming an accommodation space; a circuit substrate arranged on a floor plate of the case; a coil block electrically connected to the circuit substrate to form a space therein; a magnet including a first magnet arranged in opposition to the space of the coil block and a second magnet arranged at an exterior of the coil block; a yoke securing the first and second magnets; and an elastic member elastically securing the yoke to the case.

14. The linear vibrator of claim 13, wherein the coil block takes the shape of a pipe.

15. The linear vibrator of claim 13, wherein the first magnet takes the shape of a pillar inserted into the space of the coil block, and the second magnet takes the shape of a doughnut encompassing the coil block.

16. The linear vibrator of claim 13, wherein the first magnet generates a magnetic flux to an axial direction of the coil block and the second magnet generates a magnetic flux to a radial direction of the coil block.

17. The linear vibrator of claim 13, wherein the yoke secures the first and second magnets, and a part of the yoke encompasses a periphery of the second magnet.

18. The linear vibrator of claim 13, wherein the yoke secures the first and second magnets, and a part of the yoke encompasses the periphery of the second magnet and a bottom surface of the second magnet.

19. The linear vibrator of claim 13, wherein a bottom surface of the circuit substrate is formed with a connection terminal and the case is formed with an opening exposing the connection terminal.

20. The linear vibrator of claim 13, wherein the second magnet is formed in the plural.
